(19) United States
(12) Patent Application Publication
(10) Pub. No.: US 2026/0007992 A1
(43) Pub. Date: Jan. 8, 2026

(54) AIR FILTER

(71) Applicant: CAMFIL USA, INC., Riverdale, NJ (US)

(72) Inventor: Daniel VANGILDER, Jonesboro, AR (US)

(21) Appl. No.: 18/761,682

(22) Filed: Jul. 2, 2024

(51) Int. Cl. B01D 46/00; B01D 46/24; B01D 46/52

(52) U.S. Cl. CPC B01D 46/0093; B01D 46/2403; B01D 46/521; B01D 2271/02

(57) ABSTRACT

An air filter comprising at least one filter media pack, a frame adapted to hold the filter media pack in position in the air filter, and a seal between the filter media pack and the frame, characterized in that the seal is formed from a static dissipative resin.

### TECHNICAL FIELD

The present disclosure relates to the field of air filtration, more specifically, to an air filter having static dissipative properties.

### BACKGROUND ART

In systems where high-speed air flows are utilized, such as in the air filtration of dust or particle-containing air flow, there may be a buildup of electrostatic charge on components exposed to the air flow, and consequently, the air filter can become electrostatically charged. Electric charges can occur when electrons are removed from some of the atoms in one material and transferred to atoms in another, or possibly the same, material. This electron transfer can happen when two materials touch and perhaps rub against each other, causing electrons to move from one to the other. This movement of charges can result in a buildup of charge.

The accumulation of static charge can lead to several undesirable outcomes. For instance, the discharge of static electricity may produce a spark with enough energy to ignite flammable materials or cause dust explosion, leading to potentially harmful and destructive consequences. There could also be a risk of damage to equipment or harm to operating staff.

To prevent the harmful effects of accumulated electric charges, components that are prone to static charge buildup can be equipped with an electrical connection to a grounding point. This allows for the safe dissipation of the built-up charges. U.S. Pat. No. 7,354,474B2 discloses an example of a dust filter including a conductor to avoid electrical charge in the filter.

There is interest in providing air filters with a less complicated configuration, while still avoiding the buildup of electrostatic charges.

### SUMMARY

According to a first aspect there is provided an air filter comprising at least one filter media pack, a frame adapted to hold the filter media pack in position in the air filter, and a seal between the filter media pack and the frame, where the seal is formed from a static dissipative resin. Air filters generally comprise a seal between the filter media and the filter holding frame, in order to avoid leakage of unfiltered air to the clean side of the filter. In order to seal properly, the seal needs to be in direct contact with the filter media and the frame. By providing the seal in the form of a static dissipative resin, no separate conductive components are needed to electrically connect the filter media to the frame, thus resulting in a less complicated air filter. Since the electric connection obtained by the static dissipative resin is an integral part of the filter construction, an additional benefit is an increasingly reliable connection compared to a ground cable or wire that may unintentionally be disconnected. Suitable static dissipative resin will be described in detail below.

The filter media pack may advantageously comprise filter media including one or more static dissipative materials, and the frame may also advantageously comprise frame parts made of static dissipative material. Preferably, all components of the air filter may be electrically connected via static dissipative components or static dissipative resin. Thereby the risk of electrostatic discharge can be reduced to a minimum. The frame of the filter can in turn be connected to a filter housing, e.g. by metal to metal connection which may be grounded in conventional manner.

The provision of static dissipative seal between filter media pack and filter holding frame is beneficial in many types of air filters, and is particularly advantageous in industrial filter cartridge of the type where very high forces act on the filter and dust content in the filtered air may be especially high, since the risk of electrostatic charge buildup is particularly pronounced in such applications.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure. Hence, it is to be understood that the herein disclosed disclosure is not limited to the particular component parts of the device described or steps of the methods described since such device and method may vary. It is also to be understood that the terminology used herein is for purpose of describing particular embodiments only, and is not intended to be limiting.

### BRIEF DESCRIPTIONS OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1a is a schematic cross-sectional view of an air filter comprising a conical filter media pack and a cylindrical filter media pack according to the present disclosure;

FIG. 1b is a side view of the air filter in FIG. 1a;

FIG. 2a is a schematic view of a conical air filter;

FIG. 2b is a schematic cross-sectional view of the air filter in FIG. 2a.

FIG. 3a shows a panel type air filter;

FIG. 3b is a schematic cross-sectional view of the air filter in FIG. 3a the position A-A;

FIG. 3c is a schematic cross-sectional view of the air filter in FIG. 3a the position B-B;

FIG. 4 shows a box type air filter;

### DETAILED DESCRIPTION

Reference will now be made in detail to exemplary embodiments of the present teachings, examples of which are illustrated in the accompanying drawings. It is to be understood that other embodiments may be utilized, and structural and functional changes may be made without departing from the respective scope of the present teachings. As such, the following description is presented by way of illustration only and should not limit in any way the various alternatives and modifications that may be made to the illustrated embodiments and still be within the spirit and scope of the present teachings.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

One of the best ways to avoid the concerns associated with electrostatic discharge is to prevent the static buildup from occurring in the first place. This can be accomplished by selecting a material with the right level of conductivity. As mentioned above, the present invention provides an air filter comprising at least one filter media pack, a frame adapted to hold the filter media pack in position in the air filter, and a seal between the filter media pack and the frame, which seal is formed from a static dissipative resin. All other components in the filter may typically be conductive or static dissipative, as discussed in more detail below.

The term static dissipative refers to materials that are designed to help mitigate static electricity. Charges flow to ground more slowly and in a more controlled manner using dissipative materials compared to conductive. These materials will not generate a potential hazardous charge while also grounding many potentially hazardous charges. Typically these materials are certified to meet electronic industry standards and used for sensitive electronics. By using static dissipative materials the risk of producing a charge can be reduced, while also providing protection against existing charges. The static dissipative resin used in the air filter of the present disclosure may suitably have a surface resistivity in solid state of 1×10⁶ to 1×10¹¹ ohms/square measured at 25% RH, preferably 1×10⁶ to 1×10⁹ as defined according to ASTM test method D257.

Resins are often used as insulators and may typically generate electrostatic buildup. When resins without static dissipative properties are used, it is typically necessary to arrange a plurality of grounding wires or the like along the end part of the filter media pack in order to ensure proper discharge of electrostatic charges. However, if applying static dissipative resin for the seal between filter media pack and filter holding frame, the resin seal is an excellent material to avoid the risks associated with electrostatic discharge, without the need of arranging separate conductive wires or components between the filter media pack and the frame. Thereby, the air filter thus obtained has a less complex configuration without protruding conductor elements, and reduces risk of failures. In addition, the resin will also provide a greater degree of security compared to a grounding wire, since the risk of the connection being dislodged during handling or operation of the filter. A static dissipative resin is also more secure than wires because it grounds the whole media pack, and thus reduces the risk of failure that a point connection may have.

The static dissipative resin can advantageously be a cured-in-place static dissipative elastomer. This allows for sealing of a filter media pack having uneven or irregular surface, such as a pleated filter media pack, which has been made static dissipative. The resin can then be applied as a potting resin, involving filling uncured resin in a recess of an end pan of the filter holding frame and placing the filter media pack into the uncured resin. The uncured static dissipative resin effectively fills the irregularities of the end part of the filter media pack and provides connection between the filter media pack and the frame. The manufacture of the air filter is thereby facilitated, and assembly time is reduced, since there is no need to position and attach grounding connections to the filter media pack and the frame before applying the potting resin. Alternatively, the seal may be formed by applying the static dissipative resin to the filter media pack in a separate mold and then including the media pack with the seal into the frame.

The static dissipative elastomer may be a two-component resin, comprising a base resin and a curing agent, preferably having a mix ratio of base resin to curing agent in the range from 1:1 to 15:1, or 1:1 to 10:1 parts by volume, suitably having a viscosity range 200-50,000 cP (or mPa·s) for each component. The base resin may be selected from epoxy, polyurethane polyol, silane resin, or siloxane resin or combinations thereof. Epoxy base resin may include bisphenol-A, bisphenol-F, novolac, cycloaliphatic resin. Polyurethane polyol base resin may include polyether & polyester-type diols, triols, quadrols, & other higher functionality polyols; natural oil polyols; polycaprolactone polyols; epoxy or siloxy-modified polyols). Hardener or curing agent may be: for epoxy-amines, anhydrides, Lewis acids, phenolic curing agents; for polyurethanes isocyanates (MDI, TDI, HDI, HMDI, DDI, IPDI); for silanes and siloxanes: metal-based catalysts (i.e. Pt, Sn, Rh, etc.); peroxide-based catalysts. Hardness range of the elastomer may be 20 Shore A-90 Shore D. The elastomer system may contain other non-reactive additives such as inorganic fillers that lend themselves to certain physical properties, but which do not provide static dissipative properties.

At least one of the elastomer components may be thixotropic prior to the mixing of the two components, or the components may transition from free-flowing liquids to a thixotropic paste within the first 120 seconds after the two components are mixed together. Preferably, the static dissipative elastomer may have a gel time of 0.5-120 minutes, with gel time being defined as the elapsed time from when the components are first mixed together to when the mixed elastomer system transitions from a liquid to a semi-solid mass, as defined by ASTM test method D3056. Thereby, sufficient time is allowed for assembly of the components. The static dissipative resin suitably comprises conductive material, such as one or more of metal salts, carbon black, carbon fiber, carbon nanotubes, or conductive metal powders or filaments.

According to an example, the filter media pack may comprise filter media including one or more static dissipative materials, preferably carbon fibres or a conductive finish, preferably aluminized finish for static dissipation. If desired, the filter media pack may be fully or partially covered by a net or swatch or patch made of, or comprising, static dissipative or conductive material, e.g. made of metal or plastic material comprising metal salts, carbon black, carbon fiber, carbon nanotubes, or conductive metal powders, and suitably being in contact with or connected to the filter frame. Thereby, buildup of electrostatic charges can be prevented. The filter holding frame may further advantageously comprise frame parts made of static dissipative material, preferably metal or static dissipative composite or plastic, to further reduce the risk of buildup of electrostatic charges.

The air filter may suitably comprise one or more filter media packs and can be a pulse filter cartridge, a box type filter, a panel type filter or a v-bank filter. An industrial air filter cartridge may advantageously comprise one or more filter media packs having cylindrical or conical or polygonal or plate shape. The filter media pack is sealed to the frame by static dissipative resin.

According to an example, the air filter may comprise a cylindrical or conical pleated filter media pack. The frame may include end plates or pans on one or both ends of the filter media pack. These end plates can be in the form of a top pan and/or a bottom pan, and the end plates or pans can be open to allow air flow through the end pan or closed to cover the end of the cylindrical or conical pleated filter media pack, depending on the desired air flow direction. One or both edges of the pleated filter media pack are sealed to the end pans by a static dissipative resin seal. The top and bottom pans may be circular or rectangular and may have an outer perimeter that is larger than the outer perimeter than pleated filter media pack. The end pan can be in the form of a circular or rectangular tray or a fastening end plate, to facilitate mounting in an air filtration installation. Gaskets for sealing the end pan to adjacent equipment can be applied on the end pan.

According to an example, the air filter may comprise an outer cylindrical pleated filter media pack and an inner conical pleated filter media pack positioned inside the outer cylindrical pleated filter media pack. Such a filter is described in US2019247778A1, incorporated herein by reference. The frame may comprise end pans on one or both sides of the filter media pack, for example a top pan and a bottom pan, where the top pan is located at the end of the air filter where the tip of the inner conical pleated filter media pack is. A top cone may be positioned on a narrower end of the conical inner filter media pack. The edges of the outer cylindrical pleated filter media pack may be sealed to the end pans by a static dissipative resin seal. The wider end of the conical filter media pack may suitably be sealed to the same end pan as the cylindrical filter media pack. The top cone of the inner conical filter media pack may suitably be sealed to the top pan by a static dissipative resin seal, such that there is a resin seal between the conical filter media pack and the top cone and an additional resin seal between the top cone and the top pan. In this way, no conductive cables need to be arranged between the inner conical filter media pack and the top pane, thus simplifying the construction and design of the filter. The static dissipative resin may typically have properties and components as described above.

In a preferred example, all components of the air filter are electrically connected via static dissipative components or static dissipative resin.

The present disclosure will now be described with reference to the accompanying drawings, in which preferred example embodiments of the disclosure are shown. The terms “top” and “bottom” used in this description refer to the position of the filter when a mounting end or plate is directed upwards as shown in the drawings. In use the filter may be mounted in any direction, i.e. not necessarily with the “top end” upwards. The disclosure may, however, be embodied in other forms and should not be construed as limited to the herein disclosed embodiments. The disclosed embodiments are provided to fully convey the scope of the disclosure to the skilled person.

In the drawings the same reference numbers are used throughout for denoting filter components in different embodiments having the same or similar function in the air filter.

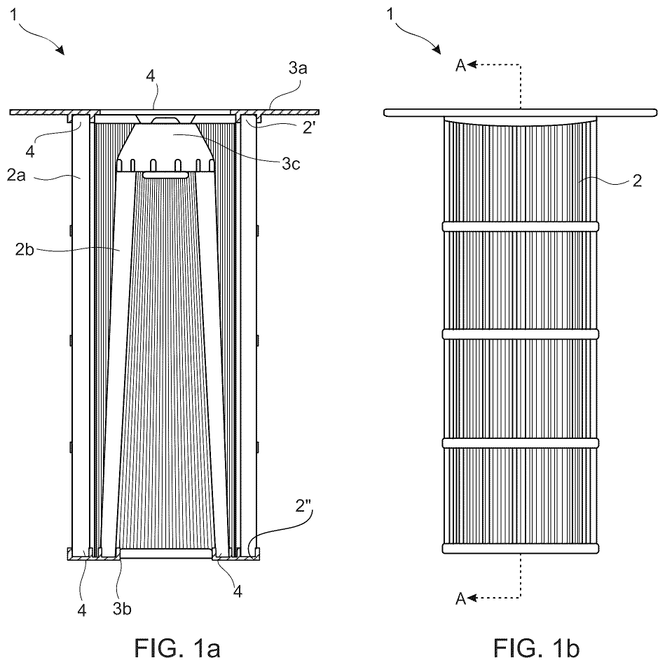

FIG. 1a is a schematic cross-sectional view along the line A-A in FIG. 1b of an air filter comprising a conical filter media pack and a cylindrical filter media pack according to the present disclosure, and FIG. 1b is a side view of the air filter in FIG. 1a;

FIGS. 1a and 1b show an air filter comprising a conical and cylindrical filter media pack according to the present disclosure. The air filter 1 comprises an outer cylindrical pleated filter media pack 2a and an inner conical pleated filter media pack 2b positioned inside the outer cylindrical pleated filter media pack. The frame includes a top pan 3a and a bottom pan 3b. A top cone 3c is positioned on a narrow end of the inner filter media pack 2b, and the top and bottom edges 2′,22 of the outer cylindrical pleated filter media pack 2a are sealed to the top pan 3a and the bottom pan 3b, respectively, by a static dissipative resin seal 4. The top cone 3c of the inner conical filter media pack is sealed to the top pan by a static dissipative resin seal 4. All components of the air filter are suitably electrically connected via static dissipative components or static dissipative resin.

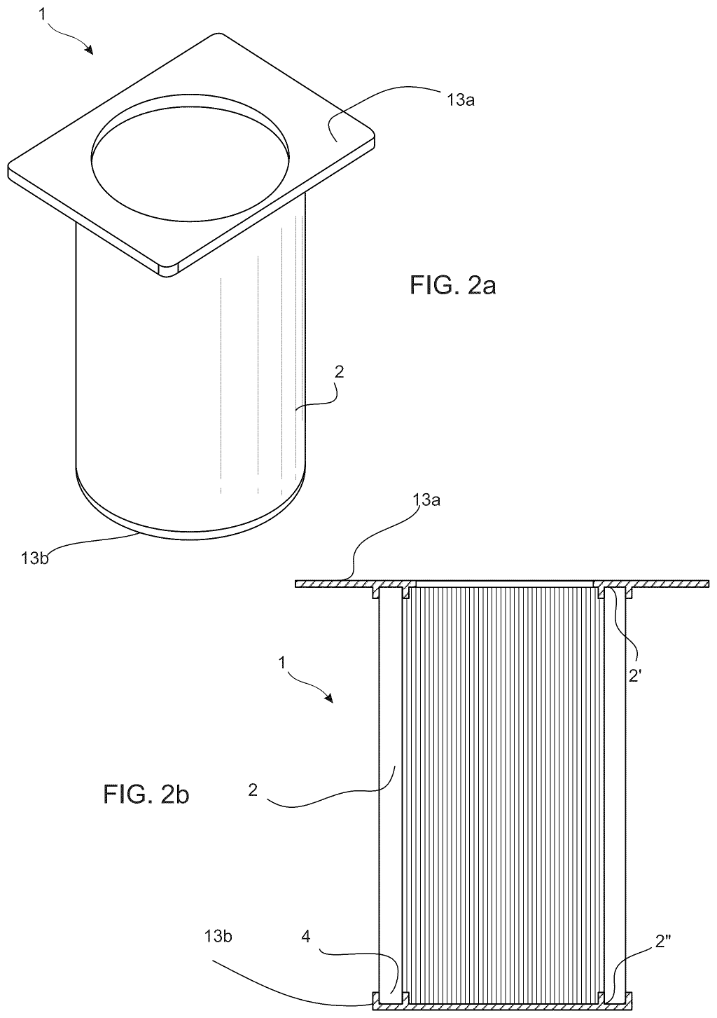

FIGS. 2a and 2b show an air filter comprising a cylindrical pleated filter media pack 2 and a frame including an open top pan 13a and a closed bottom pan 13b. The top and bottom edges 2′,2″ of the pleated filter media pack 2 are sealed to the top pan 13a and the bottom pan 13b, respectively, by a static dissipative resin seal 4.

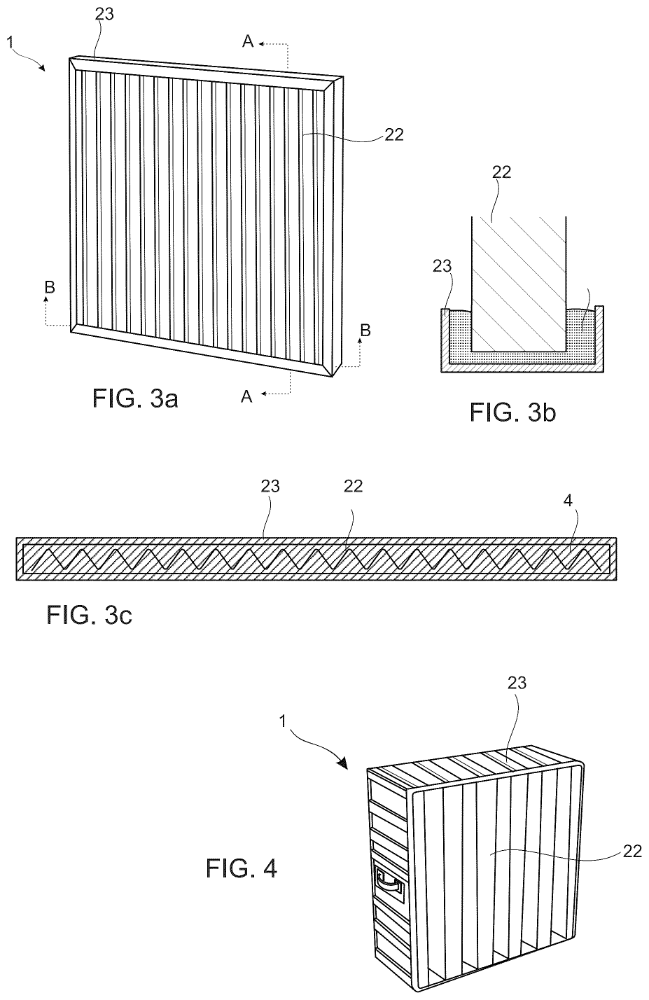

FIG. 3a shows a panel type air filter, and FIGS. 3b and 3c show schematic cross-sectional views of the air filter in FIG. 3a the positions A-A and B-B, respectively. FIG. 4 shows a box type air filter. These air filters 1 comprise at least one filter media pack 22, a frame 23 adapted to hold the filter media pack in position in the air filter, and a seal (not shown in FIGS. 1a and 4) between the filter media pack and the frame. FIGS. 3a and 3b illustrate how the seal is formed from a static dissipative resin into which the pleated air filter media has been inserted.

The filter media pack of all embodiments may be covered by a net or swatch made of static dissipative material (not shown).

The person skilled in the art realizes that the present disclosure is not limited to the preferred embodiments described above. The person skilled in the art further realizes that modifications and variations are possible within the scope of the appended claims.

### EXAMPLE EMBODIMENTS

Example 1. An air filter comprising at least one filter media pack (2, 2a, 2b, 12, 22), a frame (3, 13, 23) adapted to hold the filter media pack in position in the air filter, and a seal (4) between the filter media pack and the frame, characterized in that the seal is formed from a static dissipative resin.

Example 2. The air filter of example 1, wherein the static dissipative resin has a surface resistivity of 1×10⁶ to 1×10¹¹ ohms/square measured at 25% RH, preferably 1×10⁶ to 1×10⁹ as defined according to ASTM test method D257.

Example 3. The air filter of example 1 or 2, wherein the static dissipative resin is a cured-in-place static dissipative elastomer.

Example 4. The air filter of example 3, wherein the static dissipative elastomer is a two-component resin, comprising a base resin and a curing agent, preferably having a mix ratio of base resin to curing agent in the range from 1:1 to 15:1, parts by volume.

Example 5. The air filter of example 4, wherein at least one of the elastomer components is thixotropic prior to the mixing of the two components, or wherein the components transition from free-flowing liquids to a thixotropic paste occurs within the first 120 seconds after the two components are mixed together.

Example 6. The air filter of example 4 or 5, wherein the static dissipative elastomer has a gel time of 0.5-120 minutes, with gel time being defined as the elapsed time from when the components are first mixed together to when the mixed elastomer system transitions from a liquid to a semi-solid mass, as defined by ASTM test method D3056.

Example 7. The air filter of any one of examples 4-6, wherein the base resin is selected from epoxy, polyurethane polyol, silane resin, or siloxane resin or combinations thereof.

Example 8. The air filter of any one of examples 1-7, wherein the static dissipative resin comprises conductive material, such as one or more of metal salts, carbon black, carbon fiber, carbon nanotubes, or conductive metal powders.

Example 9. The air filter of any one of examples 1-8, wherein the filter media pack comprises filter media including one or more static dissipative materials, preferably carbon fibres or a conductive finish, preferably aluminized finish for static dissipation.

Example 10. The air filter of any one of examples 1-9, further comprising a net or a swatch or patch comprising static dissipative material fully or partially covering the filter media pack.

Example The air filter of any one of examples 1-10, wherein the frame (3) comprises frame parts made of static dissipative material, preferably metal or static dissipative composite or static dissipative plastic.

Example 12. The air filter of any one of examples 1-11, wherein the air filter comprises one or more filter media packs and is a pulse filter cartridge, a box type filter, a panel type filter or a V-bank filter.

Example 13. The air filter of example 1-11, wherein the air filter is a pulse filter cartridge comprising one or more filter media packs having cylindrical or conical or polygonal or plate shape.

Example 14. The air filter of example 13, comprising a cylindrical or conical pleated filter media pack and a frame (3) including end pans (3a, 3b; 13a, 13b) on one or both ends of the filter media pack, wherein the edge (2′,2″) on one or both ends of the pleated filter media pack (2) is/are sealed to the pan (3a, 3b; 13a, 13b) by a static dissipative resin seal (4).

Example 15. The air filter of example 14, comprising an outer cylindrical pleated filter media pack (2a) and an inner conical pleated filter media pack (2b) positioned inside the outer cylindrical pleated filter media pack, and the frame (3) includes a first pan (3a) and a second pan (3b) and a top cone (3c) is positioned on a narrow end of the inner conical filter media pack (2b), and wherein the edges (2′,2″) of the outer cylindrical pleated filter media pack (2a) are sealed to the first and second pans (3a, 3b) by a static dissipative resin seal (4), and the top cone (3c) of the inner conical filter media pack is sealed to the first pan (3a) by a static dissipative resin seal (4).

Example 16. The air filter of any one of examples 1-15, wherein all components of the air filter are electrically connected via static dissipative components or static dissipative resin.

1. An air filter comprising at least one filter media pack, a frame adapted to hold the filter media pack in position in the air filter, and a seal between the filter media pack and the frame, wherein the seal is formed from a static dissipative resin.

2. The air filter of claim 1, wherein the static dissipative resin has a surface resistivity of 1×10⁶ to 1×10¹¹ ohms/square measured at 25% RH, preferably 1×10⁶ to 1×10⁹ as defined according to ASTM test method D257.

3. The air filter of claim 1, wherein the static dissipative resin is a cured-in-place static dissipative elastomer.

4. The air filter of claim 3, wherein the static dissipative elastomer is a two-component resin, comprising a base resin and a curing agent, preferably having a mix ratio of base resin to curing agent in the range from 1:1 to 15:1, parts by volume.

5. The air filter of claim 4, wherein at least one of the elastomer components is thixotropic prior to the mixing of the two components, or wherein the components transition from free-flowing liquids to a thixotropic paste occurs within the first 120 seconds after the two components are mixed together.

6. The air filter of claim 4, wherein the static dissipative elastomer has a gel time of 0.5-120 minutes, with gel time being defined as the elapsed time from when the components are first mixed together to when the mixed elastomer system transitions from a liquid to a semi-solid mass, as defined by ASTM test method D3056.

7. The air filter of claim 4, wherein the base resin is selected from epoxy, polyurethane polyol, silane resin, or siloxane resin or combinations thereof.

8. The air filter of claim 1, wherein the static dissipative resin comprises conductive material, such as one or more of metal salts, carbon black, carbon fiber, carbon nanotubes, or conductive metal powders.

9. The air filter of claim 1, wherein the filter media pack comprises filter media including one or more static dissipative materials, preferably carbon fibres or a conductive finish, preferably aluminized finish for static dissipation.

10. The air filter of claim 1, further comprising a net or swatch or patch comprising static dissipative material fully or partially covering the filter media pack.

11. The air filter of claim 1, wherein the frame comprises frame parts made of static dissipative material, preferably metal or static dissipative composite or static dissipative plastic.

12. The air filter of claim 1, wherein the air filter comprises one or more filter media packs and is a pulse filter cartridge, a box type filter, a panel type filter or a V-bank filter.

13. The air filter of claim 1, wherein the air filter is a pulse filter cartridge comprising one or more filter media packs having cylindrical or conical or polygonal or plate shape.

14. The air filter of claim 13, further comprising a cylindrical or conical pleated filter media pack and a frame including end pans on one or both ends of the filter media pack, wherein the edge on one or both ends of the pleated filter media pack is/are sealed to the pan by a static dissipative resin seal.

15. The air filter of claim 14, further comprising an outer cylindrical pleated filter media pack and an inner conical pleated filter media pack positioned inside the outer cylindrical pleated filter media pack, and the frame includes a first pan and a second pan and a top cone is positioned on a narrow end of the inner conical filter media pack, and wherein the edges of the outer cylindrical pleated filter media pack are sealed to the first and second pans by a static dissipative resin seal, and the top cone of the inner conical filter media pack is sealed to the first pan by a static dissipative resin seal.

16. The air filter of claim 1, wherein all components of the air filter are electrically connected via static dissipative components or static dissipative resin.
